(19) United States
(12) Patent Application Publication
(10) Pub. No.: US 2010/0121684 A1
(43) Pub. Date: May 13, 2010

(54) System and Method for Capturing Information for Conversion into Actionable Sales Leads

(75) Inventors: Jason Morio, Austin, TX (US); Joel Landau, Austin, TX (US); Toby Traylor, Austin, TX (US); Suaad Sait, Austin, TX (US); Bob Riazzi, Austin, TX (US)

Correspondence Address: TAYLOR RUSSELL & RUSSELL, P.C., 10601 Ranch Road 2222, STE-R12, AUSTIN, TX, 78730-1138, US

(73) Assignee: ReachForce Inc., Austin, TX (US)

(21) Appl. No.: 12/617,556

(22) Filed: Nov. 12, 2009

Related U.S. Application Data
(60) Provisional application No. 61/113,943, filed on Nov. 12, 2008.

(51) Int. Cl. G06Q 10/00; G06F 17/00; G06Q 30/00

(52) U.S. Cl. 705/10; 707/687

(57) ABSTRACT

The system and method relates to business-to-business marketing organizations who participate in lead-generation activities via their company website, client customer relationship management systems, and other available business information. More particularly, it provides a target lead-generation system and method that targets the right businesses and personnel within those businesses using real-time predictive and behavioral analytics and website traffic data, reaches the right business buying person via role-based contact data and connects businesses to potential customers and suppliers to drive business revenue.

This application claims benefit of U.S. Provisional Application No. 61/113,943, filed on Nov. 12, 2008.

### BACKGROUND

The present invention relates to business-to-business marketing organizations who participate in lead-generation activities via their company website. More particularly, the invention provides a target lead-generation system and method that targets the right businesses using real-time predictive and behavioral analytics and website traffic data, reaches the right business buying person via role-based contact data and connects businesses to potential customers and suppliers to drive business revenue.

Business to business marketing (“B2B”) includes individuals and organizations that facilitate the sale of their products and services to other companies or organizations that often resell the products and services, or use them to support their operations. Although the difference between consumer and business marketing may appear obvious, there are many distinguishing features between the two that often result in substantial differences in practice. For example, business marketing may often involve shorter and more direct channels of distribution. While consumer marketing often involves large demographic groups targeted through mass media and retailers, in business marketing the negotiation process between the seller and buyer is more personal in nature. Most business marketing includes a much more limited portion of promotional budgets to advertising than consumer marketing, which is conducted through more direct promotional efforts, trade journals and sales calls. However, many of the principles of consumer marketing also apply to business marketing, such as defining target markets and matching product and service strengths to the defined target markets.

One of the more recent promotional endeavors of business marketing is through the Internet, involving offered services and products on organizations' websites. While popular in use, industry research has shown that of all persons who visit a business to business (“B2B”) company's website, only 3% of visitors actively identify themselves via forms, thereby leaving 97% of web visitors to remain unknown. In addition, of the 3% that announce themselves, only 40% fill out a form with complete and accurate information. This lack of information makes it very difficult to follow up a possible sales lead from a website visitor based on insufficient information.

Customer relationship management (“CRM”) systems and methods are used by organizations to provide a predictable and organized way for interacting with customers and potential customers. CRM often includes specially trained personnel and special purpose software. It is a combination of policies, processes and strategies implemented by an organization to unify its customer interactions and provide a method for tracking customer information. It often includes technology for identifying and attracting new and profitable customers as well as creating better relationships with existing customers. CRM involves many organizational aspects that relate to one another, including front and back office operations, business relationships and interactions, analysis involving target marketing and marketing strategies, and means for generating metrics for measuring the relative success of various marketing and sales efforts. It is a key component of modern marketing organizations. CRM systems include firmographic data, which includes characteristics of an organization often used for segment market analysis.

Software as a service (“SaaS”) is a model of software deployment where a provider licenses a software application to customers for use as a service on demand. SaaS vendors may host an application on their own web servers or download the application to the customer device, disabling it after use or after an on-demand contract expires. By sharing end user licenses and on-demand use, investment in server hardware may be reduced or shifted to a SaaS provider. SaaS is usually associated with business software and is considered to be a low cost method for businesses to obtain rights to use software as needed rather than licensing all hardware devices with all applications. On-demand licensing provides the benefits of commercially licensed use without the associated complexity and potentially high initial cost of equipping each hardware device with software applications that are only used occasionally. One of the early SaaS providers is Salesforce.com, which distributes business software purchased on a subscription basis and hosted offsite. They are best known for their CRM products which are delivered to businesses over the Internet using the SaaS model.

One of the major drawbacks of many of the B2B sales and marketing products available today is the lack of data quality when generating existing and new customer contact data. An ideal solution is one that provides 100% accurate contact information for the right person at the right target company. Drawbacks of current solutions include outdated and inaccurate information from listed data providers, commonly-used titles of individuals are poor predictors of a person's job function and responsibilities, and the lack of a simple and cost-effective way to objectively and analytically identify companies to target for outbound marketing. These deficiencies are magnified by the widespread use of Internet marketing, where less than 3% of website visitors are identifiable.

### SUMMARY

The present invention is a system and method to selectively identify and target marketing activities to the set of companies from which web visitors are originating but whose visitors do not actively identify themselves to the sponsoring website company. It performs as a Software as a service (SAAS) deployment.

Features of the described application for identifying website visitors includes the means of a small code fragment that can be embedded in a client's website for collecting and sending and tracking non-personally-identifiable information about passive web visitors by the present invention. As this passive web visitor data accumulates, the client can then view this data as well as other publically available company information, set up business rules to view and filter companies based on a number of visits, pages visited and firmagraphic criteria, such as industry, revenue range and employee population size.

The present invention is also a targeted lead generation system, which uses a combination of analytical applications to assist B2B marketers in identifying ideal markets and companies within those markets to target their lead generation efforts. The B2B marketing economy in 2005 was seventy seven billion dollars with almost two thirds of that amount spent in field marketing and demand generation. The top issue for companies trying to market to other businesses is reaching the correct buyer decision maker, often called a target. Billions of dollars are wasted annually in unsuccessful marketing attempts to reach the right target. Despite annual spending in 2005 of twenty seven billion dollars on demand generation activities such as email marketing, webinars, search marking and online advertisements, B2B marketers still experience zero to three percent conversion rates that is being able to reach the right target. Other related problems involve inability to measure marketing results, improving lead quality and generating more leads.

The present invention addresses the B2B marketing data gap in part by providing high quality data for B2B demand generation. A typical supply chain view of B2B marketing involves lead generation and marketing and sales force automation as part of customer relationship management which also includes customer service and support. It provides intelligence to automate and streamline lead generation and marketing and sales force automation.

The present invention solves the marketing problems of targeting the right companies with marketing and sales campaigns, targeting the right roles of likely decision makers, identifying the right segments of the market where a company is currently winning customers, identifying the deal velocity of opportunities through the sales funnel, identifying patterns in the opportunities in the sales funnel, identifying companies with the same characteristics as other companies that the business is selling to and justifying marketing spending by measuring results. It solves these problems with analytics and algorithms that target the right businesses and the right roles of likely decision makers and buyers within those businesses. Included is a custom developed workflow engine that leverages a company's internal data and third party data. Data services for targeted lead generation include custom data creation services using a role-base model of the decision maker, marketing leads, a discovery data inference engine and workflow to drive advantaged economics of data services and a data refresh and update database service for in-house leads and customer contact data. Software services for marketing decisions include targeting campaigns based on win and sales funnel analysis, leveraging web site visits and converting them into targeted leads and profiling of in-house data to surgically fix data quality issues. In summary, the present invention helps businesses target the right companies to sell to, reach the right person within those companies and connect to those persons in the right way most likely to generate a positive response.

The core of these marketing service applications is a platform for marketing and sales contact management that provides increased data quality. These include a SaaS-based data services technology platform that provides the following features.
Real-time Predictive Analytics—Automatically recommends new target businesses based on “cluster patterns” identified via real-time analysis of client win data and sales pipeline data within CRM systems and/or web visitor profiles.
An innovative Role-based data model for contact records, which can pinpoint accuracy of the right contact. This Role-based data model employs cutting-edge Web 3.0 semantic data principles to provide a unique capability for identifying the right person based on the Role of an individual aligned with a company's product/solution value proposition.
An on-demand contact discovery model based on intelligent heuristics in which contact data is generated only upon client request, resulting in fresh, 100% accurate contacts that drive performance increases of 20×-30× for marketing campaigns.
A real-time query engine technology component that will enables queries across social network destinations and augment the traditional contact data attributes, such as name, title, phone, email, with social media presence information. This “query for quorum” approach not only serves as an additional tier of contact validation but will also assist clients in formulating social marketing strategies to reach their prospects by identifying if and where those prospects are participating in social networking.

### BRIEF DESCRIPTION OF DRAWINGS

These and other features, aspects and advantages of the present invention will become better understood with regard to the following description, appended claims, and accompanying drawings wherein:

FIG. 1 illustrates a functional block diagram of an embodiment of the present invention;

FIG. 2 is an example illustration of a Resource Description Framework model for role-based contacts;

FIG. 3 is a depiction of the confluence of a client request and the validated contacts database;

FIG. 4 is an illustration of a Resource Description Framework model for company attributes;

FIG. 5 is a flow diagram of workflow with adaptive steering where “direct hits’ or “correlated” contacts are not found;

FIG. 6 is a flow diagram of an embodiment of a method for collecting and analyzing visitors of companies' websites;

FIG. 7 is a flow diagram of an embodiment of a method for identifying and associating information from web services with information from a client's customer relationship management system;

FIG. 8 depicts a client user interface for analyzing client wins data;

FIG. 9 depicts a client user interface for analyzing client funnel data;

FIG. 10 depicts a client user interface for analyzing client fastest wins data by industry, annual revenue and employee population size;

FIG. 11 depicts a client user interface dashboard view for proactively targeting lead generation; and

FIG. 12 depicts a client user interface detailed view for proactively targeting lead generation.

### DETAILED DESCRIPTION OF INVENTION

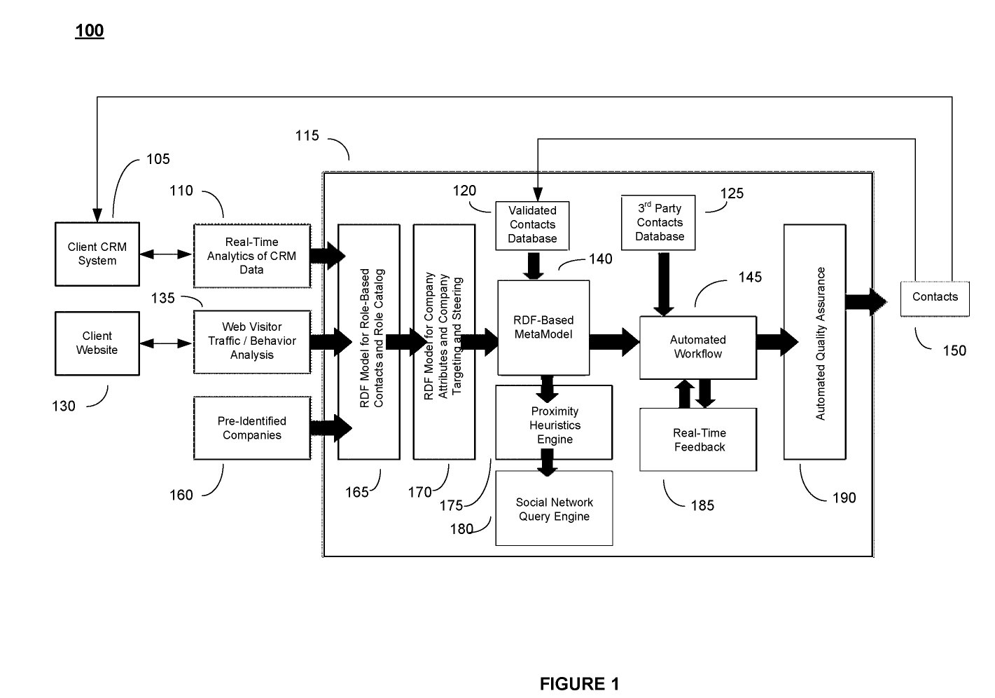

Turning to FIG. 1, FIG. 1 illustrates a functional block diagram 100 of an embodiment of the real time analytics application 110, web visitor application 135, and the data services platform 115. It provides a targeted lead-generation system that targets the right businesses using website traffic data for reaching the right business buying person via role-based contact data and connects businesses to potential customers and suppliers to drive business revenue.

### Real-Time Analytics

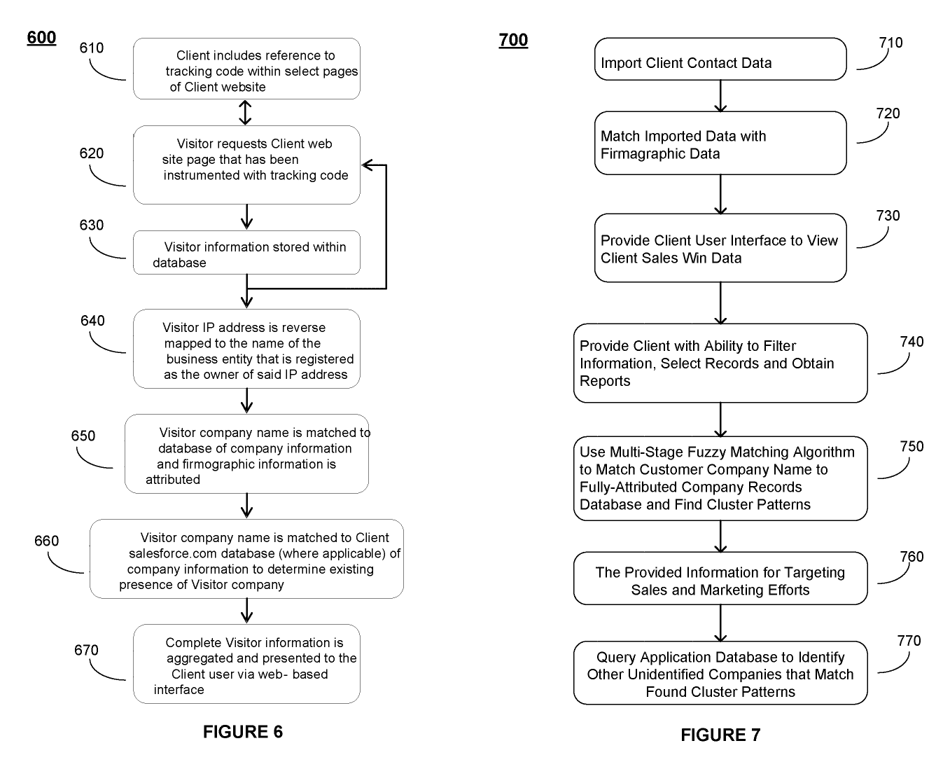

In FIG. 1, a Customer Relationship Management (CRM) System 105 is a hosted software application as a service (SaaS) instance of a type of sales force automation software including but not limited to salesforce.com software. This CRM application 105 is used by the client as a system of record for tracking sales and marketing data, such as leads, contacts, accounts, opportunities and client wins. Client CRM data 105 is accessed by the real time analytics application 110 for creating a list of companies within which contacts and sales leads are desired. The real time analytics application 110 includes a set of self-service analytics tools that enable clients to create target company lists based on objective criteria, such as a client's CRM system. A more detailed description of this real time analytics application 110 is discussed below in relation to FIG. 7.

### Web Visitor Application

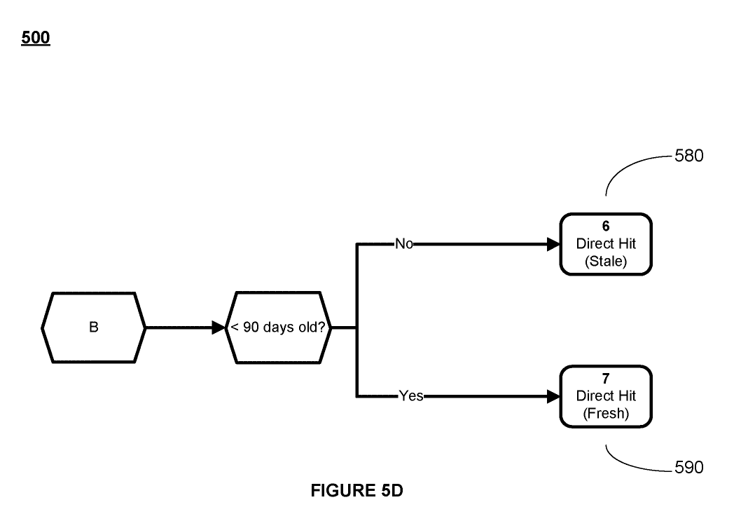

FIG. 1 also includes a web visitor application 135 that receives data from client website visitor information from a code segment embedded in the client website 130. This web visitor application 135 is provided for clients who wish to focus their contact discovery efforts on companies that are frequenting their corporate website 130. This application 135 employs reverse-IP address lookup technology to identify, from an IP address of a client website visitor, the name of the company to which the IP address belongs. From there, a multi-stage matching algorithm is used to augment each reverse-mapped company name with firmagraphic information. A client user can then sort, filter and prune through the full list of visiting companies to identify a target set that matches their needs and provide that list to the data services platform as a target list. A more detailed description of this real time analytics application 110 is discussed below in relation to FIG. 6.

It should be noted that at times clients will have a prepared list of companies 160 or are able to express the firmagraphic characteristics of the types of companies they are intending to target. In these cases, the companies or parameters are input to a list building tool provided as a part of the data services platform functionality.

### Role-Based Contact

As shown in FIG. 1, target company data from the real time analytics application 110, the web visitor application 135, and the pre-identified companies 160 may be provided to the role-based contacts component 165. With a target company list identified, the next step is selecting the right role description by the role-based contacts component 165, or modifying one from the role catalog 165. A role description is an English-language definition of job function that makes a target contact ideal for the client's marketing requirements. To illustrate, roles can typically be described by completing the following sentence:

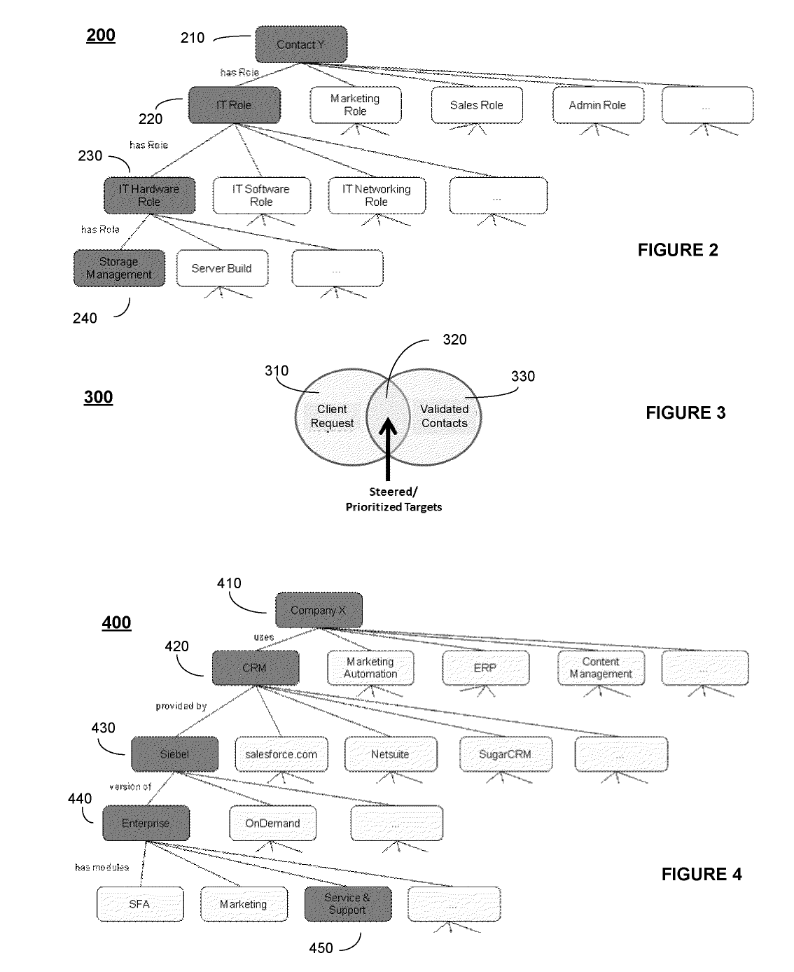

We are targeting the person responsible for ______.
It is often the case that this role description is augmented with supplementary bounding information around suggested titles and departments to specifically seek and/or avoid. An example of this more sophisticated description would be:
We are targeting the person responsible for ______. This person is typically in the ______ or ______ department and may carry the title of ______ or ______. This person must explicitly not reside in the ______ or ______ department and must not bear the title of ______ or ______.
This vernacular is often foreign to marketers whose innate response when questioned about who they are targeting is a title-based response, such as “the VP of Sales” or “Director of IT”. The role catalog 165 assists clients in reshaping their thinking around roles instead of titles, which are poor predictors of the job functions a person actually performs. The role catalog 165 is a unique hybrid-Resource Description Framework (“RDF”) 140, a semantic data representation of stored information that contains mappings of titles to roles. A more detailed description of this RDF model 140 for role-based contacts 165, 170 is discussed below in relation to FIG. 2.

### Company Targeting

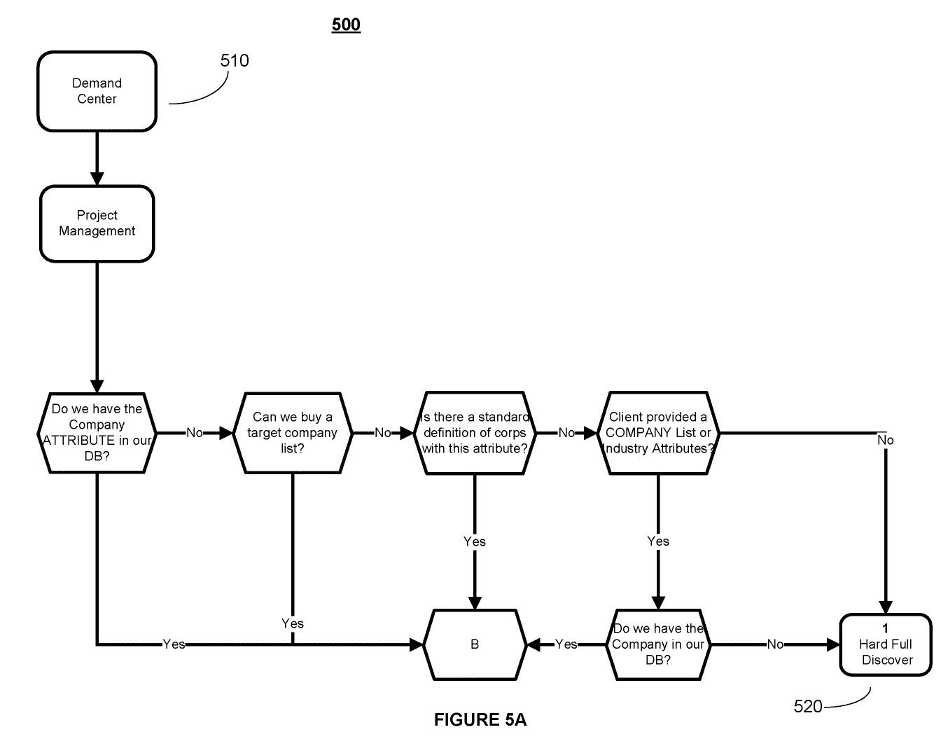

Once the target company list 110, 135, 160 and roles 165 have been identified, the contact discovery process is then initiated and several technology components are employed to maximize the leverage of existing information around titles, roles, companies and contacts to drive discovery costs downward. These components are company targeting and steering component 170 and the proximity heuristics engine component 175. The company targeting and steering component 170 is described in greater detail below in relation to FIG. 3. This component 170 steers a list of target companies by searching for companies that intersect between the client-defined criteria set and companies previously researched that are contained in the validated contact database 120. Where contacts match a target company and a role criteria, the result is considered a “direct hit”.

### Proximity Heuristics

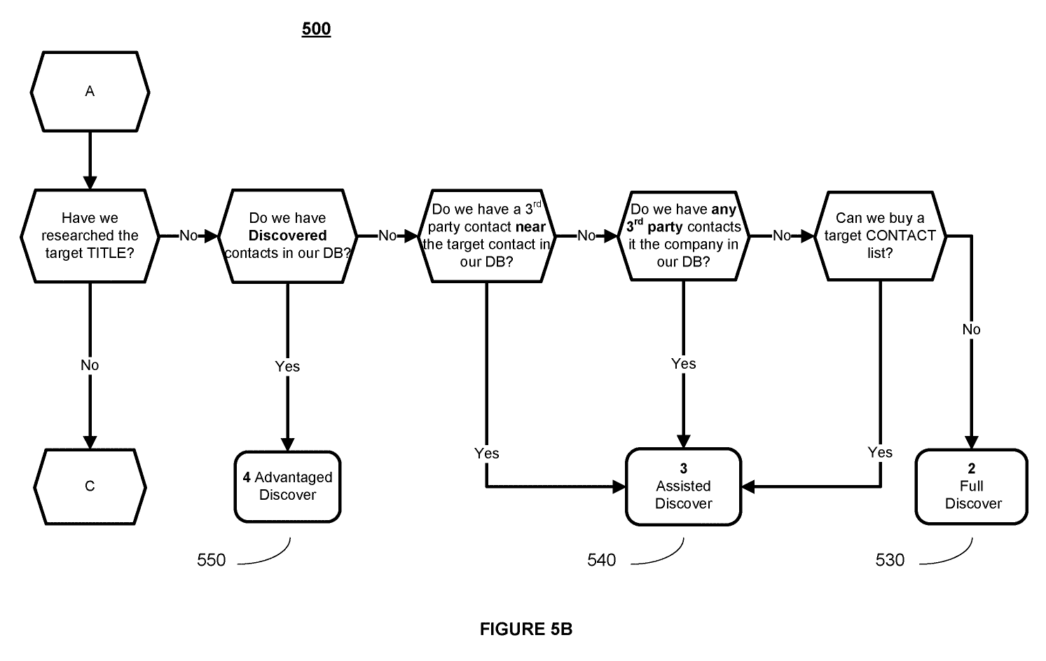

The proximity heuristics engine component 175 relies on an underlying data model of the data services platform 115 that is an intelligent model that draws upon the Classifier and Statistical Learning methods of artificial intelligence. This model increases accuracy and relevance, i.e. “gets smarter”, as more data is created within it. Information about all dimensions of the data produced, such as titles, roles, companies, contacts, are leveraged for present and future contact production, refresh or verification cost advantages. When a target role enters the system at a discovery initiation point, the system employs a heuristic statistical distribution model to match, correlate and provision existing contacts that directly match or are in close proximity to a desired role as determined either by existing role or title. Where existing contacts directly match or are in close proximity to a desired role within a defined threshold, the match is considered to be “correlated”. The proximity heuristics engine component 175 is described in greater detail below in relation to FIG. 4.

### Automated Workflow

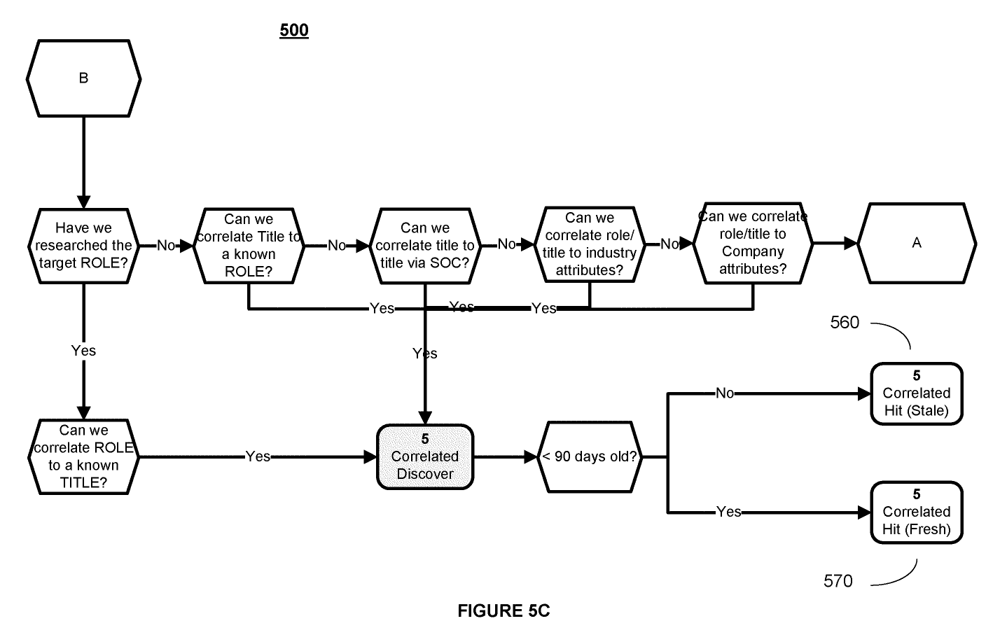

As noted above, where contacts match a target company and a role criterion, the result is considered a “direct hit”, and where existing contacts directly match or are in close proximity to a desired role within a defined threshold, the match is considered to be “correlated”. For the remainder set of target companies where “direct hit” or “correlated” contacts were not found, the data services platform 115 provides an automated workflow 145 that guides researchers through the explicit set of process steps and transitions required to find or refresh the right role-based contacts. The automated workflow component 145 is described in greater detail below in relation to FIG. 5. The real-time feedback component 185 is a non-automated function of the data services platform 115.

### Validation and Quality Assurance Technologies

As contacts are successfully discovered, the data services platform 115 employs a host of processes and automated quality assurance technologies 190 delivered within the contact manufacturing line to ensure that a contact is, in fact, the right contact and that the information that has been provided about the contact is accurate. Every contact that is released to clients undergoes the following automated verification and validation processes:
Email address validation—the system employs an intelligent scoring-based proprietary set of Internet research techniques to improve upon existing commodity methods, which generates a score for each email address in the range of [0 . . . 5]. Only contacts with email addresses scoring a 4 or 5 rating will be released to the client.
CASS address verification—the geographic attributes of each contact are validated against third party services to ensure accuracy and deliverability for direct mail performance.
Search engines and other Internet resources, such as LinkedIn, FaceBook and others are used to further verify that the contact exists at the stated company and that they fulfill the target role description.
Event logging produces forensics data enabling QA resources to validate that the appropriate steps were taken to discover and validate contact data and role applicability.
In-stream title analysis ensures contacts with titles that fall out of desired specification do not proceed through the workflow.
Dual-stage quality processes ensure role attribution and physical contact data are correct for each contact through VOIP call recording analysis, optimized web search tools and logging.

Taken together, these processes are effective in ensuring delivery of a high quality contact. The data services platform includes a real-time social network query engine component 180 to further these quality assurance methods by interrogating social network destinations to test for contact presence. The contacts 150 identified as a result of the automated workflow component 145 and the automated quality assurance component 190 are stored in the contacts database 120 of the data services platform 115 and in the clients' CRM systems.

### Reporting and Instrumentation

The Data Services Platform requires a low skill barrier to usage and productivity. Contact discovery projects are delegated, monitored, tracked and measured throughout the process lifecycle by Project Managers. Researchers are provided with a rigid process flow that navigates them through the various stages of contact discovery and provides various means of assistance throughout the process.

The system is instrumented pervasively for reporting and analysis across several dimensions including quality, milestone achievement, productivity, performance, and capacity and revenue forecasting. Project Managers and Executives have access to real-time business intelligence that provides for facilities such as:
Researcher efficiency grading, enabling managers to monitor, guide and take steps to improve individual researcher performance
Project and Agent level KPIs, enabling managers to guide projects to completion faster with less error.
Stage-level cycle-time analysis, illustrating areas of the ‘manufacturing line’ which need staffing modifications to ensure faster throughput.
Role penetration analysis, enabling determination of Role definition performance
Assignment and reallocation of researchers to activities aligned with their skill levels
Dynamic adjustment of capacity for active researchers within and across research centers
Production capability and planning, enabling managers to scale resource needs to match production needs and capabilities.
Revenue forecasting, enabling managers to make intelligent planning decisions in real-time
Reject analysis to surface error cluster trends, enabling in-process changes to project definitions and attainment of velocity and quality goals while reducing effort and opportunity waste.
Productivity hotspots, enabling managers to scale down research resources during slow periods and anticipate potential performance bottle necks.

Turning to FIG. 2, FIG. 2 is an example illustration of a Resource Description Framework model and role catalog 200 for role-based contacts. Contact Y is first identified 210 and has an IT role 220, an IT hardware role 230 and an IT storage management role 240. The role catalog 165 contains mappings for thousands of unique roles, spanning unique titles across a universe of over 600,000 contacts in the contact database 120. This catalog is text-indexed for search purposes and is used to illustrate the role paradigm to clients and prompt them to either select an existing role or modify an existing role.

In cases where neither a match nor template can be found that is similar enough to the client's role, the client can create a new role which will be used for their contact discovery purposes, thus extending the role catalog for future use. Once the target company list and roles have been identified, the contact discovery process is then initiated and several technology components are employed to maximize the leverage of existing information around titles, roles, companies and contacts to drive discovery costs downward. These components include the Company List Steering and the Proximity Heuristics Engine.

Turning to FIG. 3, FIG. 3 is a depiction 300 of the confluence 320 of a client request 310 and a validated contacts database group 330. In cases where the clients either have firmagraphic criteria that describes the set of companies they wish to target or are open to supplementing an explicit list of target companies with additional companies matching a set of firmagraphic criteria, the data services platform 115 is able to “steer” the resulting target list of companies by searching for companies that intersect between the client-defined criteria set and companies previously researched, and therefore contain existing contacts. This advantages the discovery process, at a minimum, by surfacing a set of companies for which has known good contacts that match the client's target role description. In the optimal case, contacts that match both the target company and Role criteria are rendered, resulting in a “direct hit”. In the event of a “direct hit” where the contact validation date is beyond a stated aging threshold of 90 days, the data services platform 115 will not automatically provision that contact directly to the client. Instead, the data services platform will conduct a faster, lower cost refresh process to verify that the contact data and role responsibility is still current before shipping it to the client.

Turning to FIG. 4, FIG. 4 is an illustration 400 of a Resource Description Framework model for company attributes and company list steering 170. In the example of FIG. 4, Company X 410 uses a CRM system 420, provided by Siebel 430, a version of Enterprise 440 Services and Support 450. The underlying data model of the data services platform is an intelligent model that draws upon the Classifier and Statistical Learning methods of artificial intelligence. This model increases accuracy and relevance (i.e. “gets smarter”) as more data is created within it. Information about all dimensions of the data produced by the data services platform, including titles, roles, companies, contacts, which are leveraged for present and future contact production, refresh or verification cost advantages. When a target role enters the system at the discovery initiation point, the system employs a heuristic statistical distribution model to match, correlate and provision existing contacts that directly match or are in close proximity to a desired role as determined either by existing role or title. If the number of times Title_{Tx} occurs for Role_{Ry}>=Threshold_{Dn}, the engine infers that Title_{Tx} is a likely candidate to match the target Role_{Ry}. Depending on the depth of information around the target titles and roles, the system may derive several such titles for a given request. In circumstances where the specific role for a target company is not found but contacts exist, the correlation engine can determine if any of those contacts perform or are likely to perform the desired role. This engine can correlate role-to-title relationships even when the list of target companies varies significantly in size or revenue.

The hybrid-Resource Description Framework (RDF) data model also supports tagging of company attributes outside of the stock firmagraphic criteria. Information about technologies deployed within companies and other internal characteristics are persisted and stored in a hybrid-RDF format for advanced company data mining. The heuristics engine can not only predict likely titles for desired roles, but also identify which companies are most likely to employ people with those desired roles. Capturing the knowledge of relationships between roles and companies drives more precise targeting and selection of companies.

Turning to FIG. 5, FIG. 5 is a flow diagram of workflow 500 with adaptive steering where “direct hits” or “correlated” contacts are not found. Where “direct hit” or “correlated” contacts were not found, the Data Services Platform provides an automated workflow that guides researchers through the explicit set of process steps and transitions required to find or refresh the right role-based contacts. FIG. 5 depicts a receipt of contacts 510 where “direct hits” or “correlated” contacts are not found. It shows the steps of the workflow process 500 that transform the received contacts 510 into a Hard Full Discover 520, a Full Discover 530, an Assisted Discover 540, an Advantaged Discover 550, a Stale Correlated Hit 560 (over 90 days since refreshed), a Correlated Hit 570, a Stale Direct Hit 580 (over 90 days since refreshed), and a Direct Hit 590. To assist researchers in their efforts to locate the target role-based contacts, the system once again leverages the Proximity Heuristics Engine 175 to query third party contact data sources 125 for contacts at the target company, at a minimum, and, where possible, likely to be in proximity to the desired contact based on title. As the discovery process operates, the system provides real-time feedback mechanisms to researchers that indicate which characteristics of their delivered contacts (ex. titles, departments) are resulting in higher approval rates. This enables researchers with in-process discovery items to hone their efforts and adapt their discovery tactics to produce higher yields and higher quality contacts that align to the clients' requirements.

Turning to FIG. 6, FIG. 6 is a flow diagram of an embodiment of a method 600 for collecting and analyzing visitors of companies' websites. The web visitor application 600 (135 in FIG. 1) provides for enabling the selective identification and targeting of marketing activities to the set of companies from which web visitors are originating but whose visitors do not actively identify themselves to the company. The client is provided a small code fragment 610 to be embedded in the client's website that will capture and send non-personal visitor information to a data capture service provided by the web visitor application (110 in FIG. 1). Once the code fragment is in place, as visitors arrive on the pages of the client's website that have been instrumented with the code fragment, information about the visitor is transmitted to the web visitor application 620. The information that is transmitted is the entire set of fields and values provided via the HTTP Request Header as specified via the HTTP protocol specification and does not include any personally identifiable information about the visitor, such as the visitor's first and last name, phone number or email address. This information is stored within a database accessible by the web visitor application 630. On a periodic basis, a scheduled program automatically processes all the web visit data for the current accumulation period and resolves collected IP addresses from the website visit information into the names of the business entities from which the visit originated 640. If no business entity name can be found for a given IP address or the IP address resolves to an Internet Service Provider (ISP), such as roadrunner.com, aol.com, yahoo.com, the visit record is excluded from rendering by the user interface. After the business entity name has been resolved, an attempt to match each business entity name against a database containing company names and firmagraphic information, such as industry, revenue and employee population size, is performed 650. For business entities that are matched successfully, the source record is attributed with the corresponding industry, revenue and employee population size values 660. If a match cannot be found, the business entity record is excluded from rendering by the user interface. Usenet an IP address, the system can render the name of the company and the company's firmagraphic attributes which can then be used by the system to identify similar companies with like attributes. The system can then find the right people to target within those companies along with their contact information. This process and functionality continues and repeats for the duration that the code fragment 610 remains on the client website. To retrieve the processed and attributed visitor data, the client is provided with a web-based user interface 670 to access stored visitor data originating from the code fragment as described previously. This user interface enables the user to select a timeframe of visit data to analyze and renders the visit data accordingly. The data is rendered in two views; one graphical depiction showing concentrations of visitor data by company headquarter location and industry, and one non-graphical table view of the visitor data and its associated attributes. Users of the Customer Relationship Management (CRM) systems that automate sales automation such as salesforce.com are also presented with the option to perform a proxy login to their respective sales force automation account (see 105 in FIG. 1) to enable the system to perform an analysis of which visiting companies are present within the user's sales force automation CRM database.

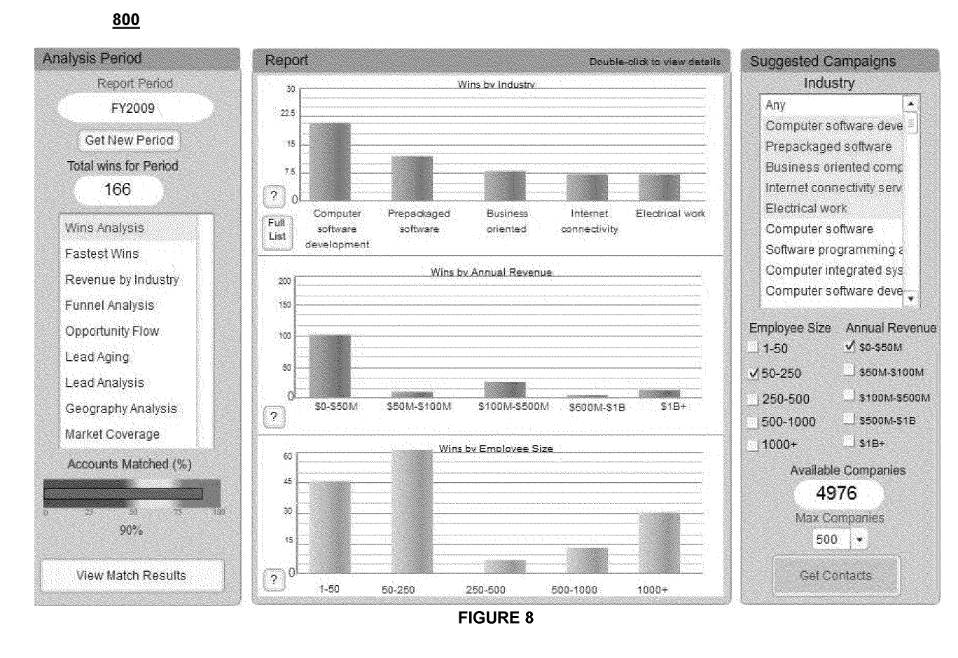

Turning to FIG. 7, FIG. 7 is a flow diagram of an embodiment of a method for identifying and associating information from web services 700 with information from a client's customer relationship management system. The purpose of this contact discovery process is to create a list of companies within which contacts are desired. The data services platform provides a set of self-service analytics tools that enable clients to create target company lists based on objective criteria, such as client's CRM system. This analysis assumes very little data integrity within the user's CRM system and only the names of the companies identified in the user's CRM system as either clients or active prospects are used to initiate the segmentation process. It is through the means of a multi-stage fuzzy matching algorithm that the application matches the user's company names to fully-attributed company records in the master database. The results of this analysis are then aggregated and the user is presented their “cluster patterns”, or firmagraphic descriptions of companies which the user's customers and/or prospects are found to be in highest concentration. Once these cluster patterns are ascertained, the application then queries the database to surface the number of other companies that match the identified cluster patterns that the user does not currently have resident in their CRM system, thus presenting the remaining total addressable market available for a particular cluster pattern. This list of companies derived from this process then serves as the input list of target companies within which the contact discovery processes is performed. The process comprises importing client contact data from the client's CRM system 710 and matching the imported data with firmagraphic data 720. The client is provided with a user interface to view client win data 730 (see FIG. 8), and allows the client the ability to filter information, select records and obtain reports 740. A multi-stage fuzzy matching algorithm is used to match customer company names to a fully-attributed company records database and find cluster patterns 750. The user interface provides information for targeting sales and marketing efforts 760 and allows a user to query the application database to identify other unidentified companies that match the found cluster patterns 770.

Table 1, shown below, depicts the ability of a user to select a set of companies or the entire list of companies for examination. The user can also filter the list of companies by industry, revenue, employee population, location or any combination thereof. The user may also elect to export the active list, which results in the creation of a tab-delimited text file on a server containing all respective information for each selected company. This file can then be harvested by a human employee and either processed in the context of a discover data services project or simply made available to the user via email attachment.

TABLE 1

| Com- | | | | | | |
|---|---|---|---|---|---|---|
| pany | Industry | Revenue | Employees | Location | Visits | In CRM |
| C1 | I1 | R1 | E1 | HQL1 | N1 | True/ |
| | | | | | | false/- |
| C2 | I2 | R2 | E2 | HQL2 | N2 | True/ |
| | | | | | | false/- |
| . . . | . . . | . . . | . . . | . . . | . . . | . . . |
| Cn | In | Rn | En | HQLn | Nn | True/ |
| | | | | | | false/- |

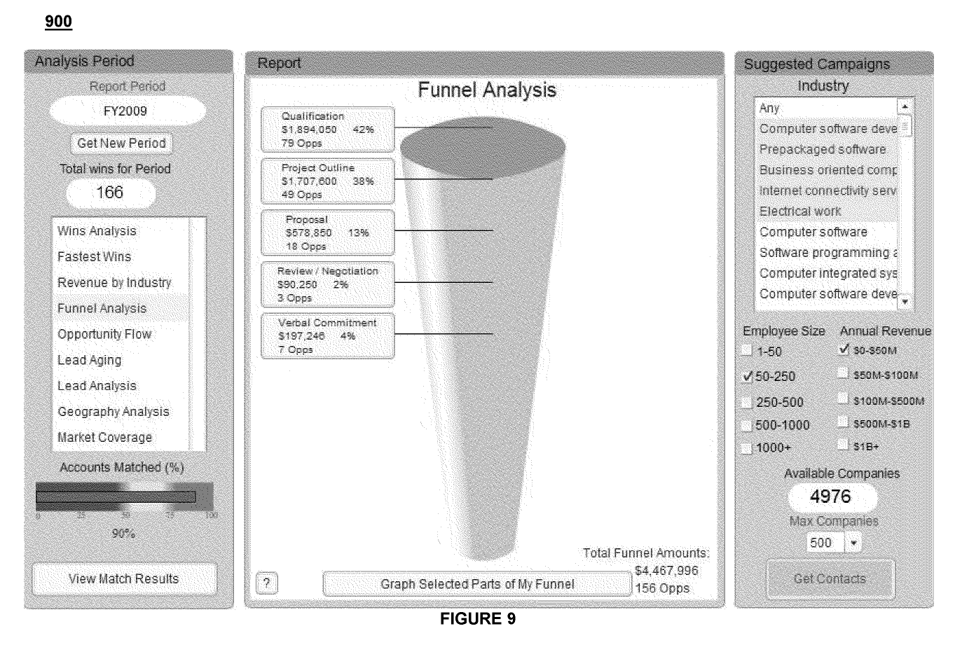

Turning to FIG. 8 and FIG. 9, FIG. 8 and FIG. 9 depict a client user interface for analyzing client wins data, where FIG. 8 depicts selection of wins analysis 810 and FIG. 9 depicts selection of funnel analysis 910. This SAAS application analyzes, augments and reports on “in-funnel” sales data, turning static information into actionable campaigns based on current deal flow. It allows a company to determine if they are marketing to the right companies, identify trends in a sales funnel that a company is not capitalizing on, identify the kinds of leads that move through the sales funnel the fastest and generate the most revenue, all of which are common questions marketers ask themselves as they are developing lead generation programs. The information that results from this application allows marketing and sales teams to agree on winning target markets and focused lead generation efforts at other companies that match this profile. In addition to highlighting winning market segments, the application allows marketing and sales teams to look into their sales funnel and identify current trends. By analyzing opportunities in the sales funnel in real time, marketers can adjust programs on-the-fly to help keep deals moving to close.

The application provides a snapshot of a company's winning market segments and the activities that contributed to these wins.

As shown in FIG. 8, a client wins analysis allows a client to highlight winning market segments, identify how many more companies have similar profiles to winning segment, highlight new client wins with the shortest sales cycles, pinpoint the kinds of companies that move through the sales funnel the fastest, and allows marketing and sales teams are able to better target outreach efforts. FIG. 9 illustrates how a client may use a funnel sales analysis to understand patterns within opportunities in the active sales funnel, better forecast new client wins, focus efforts on industries that are driving the most revenue for the business, and create or adjust marketing programs to help move opportunities to close. These figures provides identification of the set of companies that match the desired profile, and the system shown in FIG. 1 provides additional data services for role-based contact discovery within these new target companies. The combination of the application shown in FIG. 8 and FIG. 9 with the data services, allows marketing and sales teams to ensure they are reaching out to not only the right businesses but also the right decision making roles within those businesses.

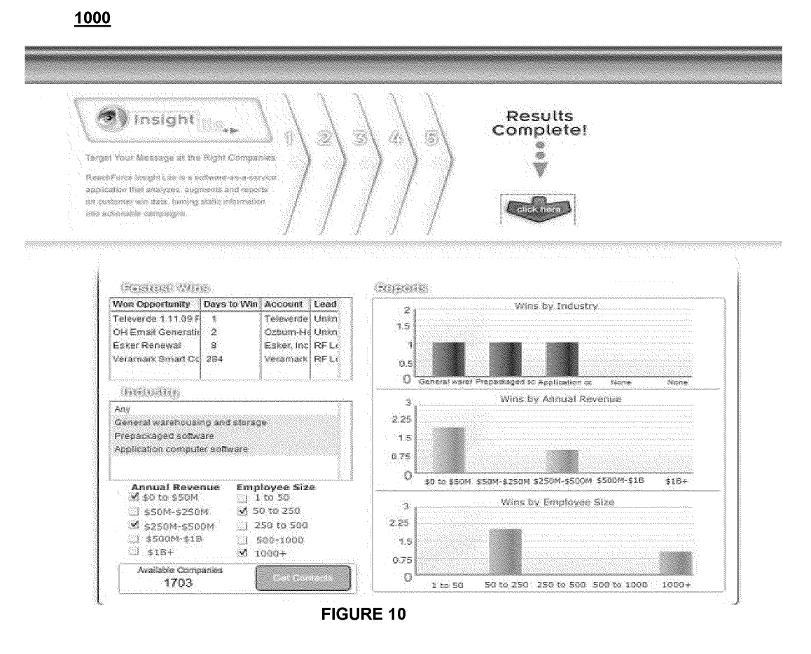

Turning to FIG. 10, FIG. 10 depicts a client user interface 1000 for analyzing client fastest wins data 1010 by industry, annual revenue and employee population size. This feature enables greater efficiencies is increasing the velocity of wins.

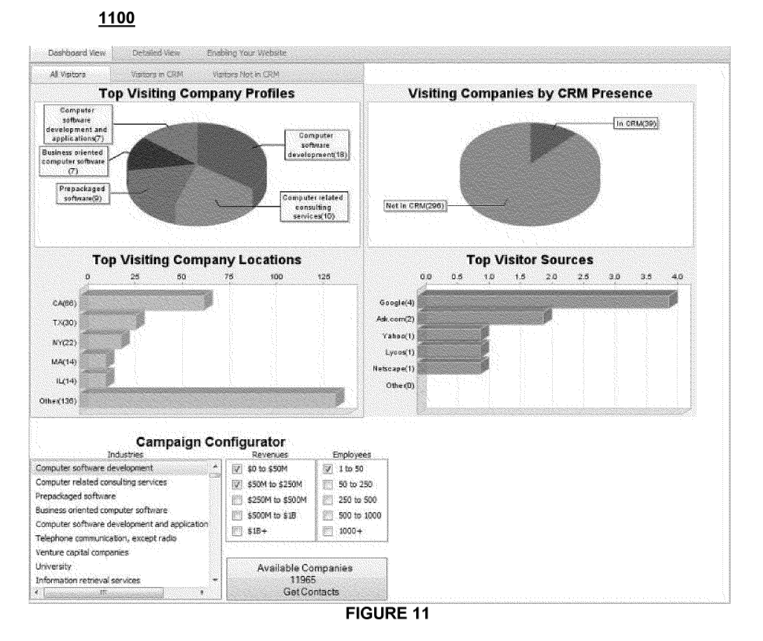

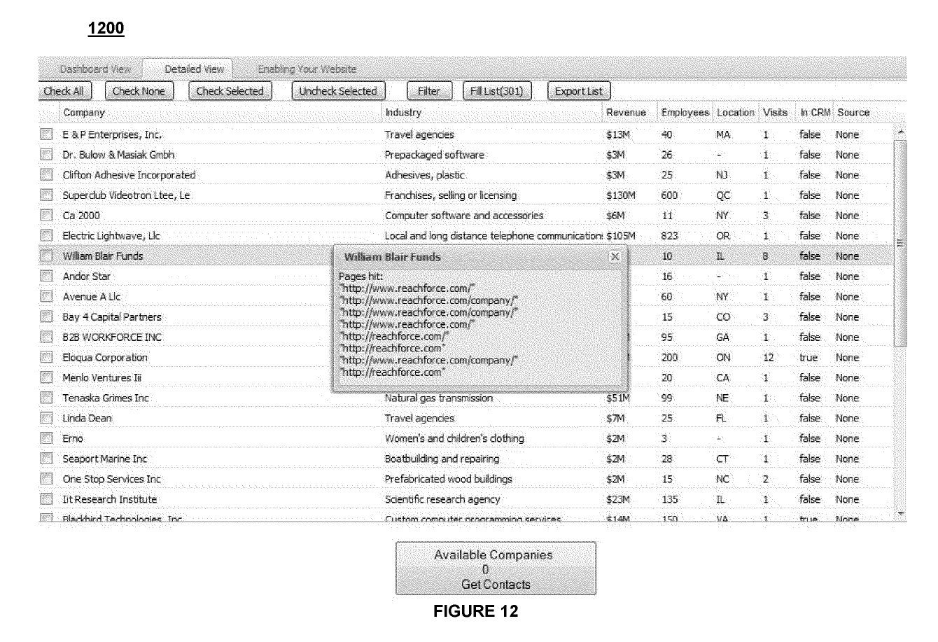

Turning to FIG. 11 and FIG. 12, FIG. 11 depicts a client user interface 1100 dashboard view 1110 for proactively targeting lead generation and FIG. 12 depicts a client user interface 1200 detailed view 1210 for proactively targeting lead generation. These user interfaces provide for setting up business rules to select, filter, review, prioritize and potentially score visitors based on the companies that are visiting, number of visits, pages visited and time on website and proactively targets unannounced web visitor. They provide reporting on where inbound visitors are coming from, such as search engines, blogs, email campaigns, as well as where the companies are geographically located. They also enable profiles of top visitors by industry and appends these records with industry verticals, SIC codes, revenue and employee population size. With this data, a company can better target unannounced visiting companies but also get contacts from companies with similar profiles. Once the companies that are visiting the website unannounced have been identified, the system shown in FIG. 1 provides data services for role-based contact discovery within these new target companies.

Although the present invention has been described in detail with reference to certain preferred embodiments, it should be apparent that modifications and adaptations to those embodiments might occur to persons skilled in the art without departing from the spirit and scope of the present invention.

1. A method for capturing information for conversion into actionable sales leads, comprising the steps of:
collecting client customer relationship management system information, client website visitor information, and pre-identified companies information;
processing the collected information for generating a target list of contact companies;
using role based resource description framework modeling, identifying contact roles of contact individuals within the list of contact companies;
using company attribute based resource description framework, identifying contact companies having client defined target company attributes that match attributes of previously researched companies contained in a validated contact database;
using a proximity heuristics engine, correlating titles and roles of contact individuals within contact companies;
creating a contact list based on the identified contact roles and correlated contact roles of contact individuals within the identified contact companies; and
storing the created contact list in the validated contact database and the client customer relationship management system.

2. The method of claim 1, further comprising the step of guiding researchers through an explicit set of steps and transitions of an automated workflow and adaptive steering process for non-identified and non-correlated contact companies.

3. The method of claim 1, further comprising the step of validating identified and correlated contact companies, including the steps of:
validating email addresses of each contact company;
verifying geographic attributes of each contact company;
verifying existence of a contact individual at a contact company;
logging events for steps taken in an automated workflow process;
analyzing contact titles for validity; and
ensuring that role attribution and physical contact data are correct.

4. The method of claim 1, wherein the step of collecting client customer relationship management system information includes the steps of:
importing client contact data from a client customer relationship management system;
matching the imported data with firmographic data;
providing a client user interface for viewing win data;
providing the client user interface with the capability to filter data, select records, and obtain reports;
using a multi-stage fuzzy matching algorithm, matching and correlating the imported client contact data with data in the validated contact database; and
storing the matched and correlated imported client data in the validated contact database and the client customer relationship management system.

5. The method of claim 1, wherein the step of collecting client website visitor information includes the steps of:
embedding a tracking code segment within selected pages of a client's website;
accessing a selected page of the client's website by a website visitor;
collecting and storing information associated with the website visitor;
reverse-mapping an IP address associated with the website visitor to a name of a visitor company owner of the IP address;
matching the name of the visitor company owner to company and firmographic attributes and information in the validated contacts database;
matching the name of the visitor company to a commercial database of company information for verifying visitor company; and
aggregating and sending visitor company information to a client user interface, a client customer relationship management system, and a data services system.

6. The method of claim 1, wherein the step of identifying contact roles further includes matching a contact role of contact individuals within the list of contact companies with a role description in a role catalog database.

7. The method of claim 6, further including the step of modifying an existing contact role to provide a match with a new contact role.

8. The method of claim 1, wherein the step of identifying contact companies includes matching both target company attributes and contact role criteria resulting in a direct hit.

9. The method of claim 1, wherein the step of identifying contact companies includes matching attributes of technology employed within a company, organizational structure, and people employed in particular roles.

10. The method of claim 1, further comprising the step of refreshing a validated contact where a contact validation date of the validated contact is beyond a predefined period.

11. The method of claim 1, wherein the step of correlating titles and roles further includes a heuristic statistical distribution model for matching, correlating and provisioning existing contacts that directly match and are in close proximity to a desired contact role as determined by an existing role and title contact.

12. The method of claim 2, further including the steps of:
accepting a non-identified and non-correlated contact company as an input;
processing the input through the explicit set of steps and transitions of the automated workflow and adaptive steering process; and
providing an output selected from the group consisting of a hard full discover, a full discover, an assisted discover, an advantaged discover, a stale correlated hit, a fresh correlated hit, a stale direct hit, and a fresh direct hit.

13. The method of claim 1, further comprising the step of analyzing client wins data on a user interface, including the steps of:
analyzing wins data by industry;
analyzing wins data by annual revenue; and
analyzing wins data by employee population size.

14. The method of claim 1, further comprising the step of analyzing client sales funnel on a user interface, including the steps of:
analyzing prospected sales opportunities;
analyzing qualified sales opportunities;
analyzing projected sales opportunities;
analyzing proposal sales opportunities;
analyze opportunities under review and negotiation; and
analyze opportunities under a verbal commitment.

15. The method of claim 1, further comprising the step of analyzing client fastest wins data on a user interface, including the steps of:
analyzing fastest wins data by industry;
analyzing fastest wins data by annual revenue; and
analyzing fastest wins data by employee population size.

16. The method of claim 1, further comprising the step of proactively targeting sales lead generation on a user interface based on website visits, including the steps of:
targeting visiting companies having a customer relationship management presence;
targeting visiting companies based on company profiles; and
targeting visiting companies based on location.

17. The method of claim 16, further including the step of selecting companies to target based on a list of companies and associated revenue, employee population size, location, number of website visits, and whether they are in a clients customer relationship management system.

18. A method for capturing information for conversion into actionable sales leads, comprising the steps of:
collecting client customer relationship management information, including the steps of:
importing client contact data from the client customer relationship management system;
matching the imported data with firmographic data;
providing a client user interface for viewing wins data;
providing the client user interface with the capability to filter data, select records, and obtain reports;
using a multi-stage fuzzy matching algorithm, matching and correlating the imported client contact data with data in the validated contact database;
storing the matched and correlated imported client data in a validated contact database and the client customer relationship management system;
processing the collected information for generating a target list of contact companies, including the steps of;
identifying contact roles of contact individuals and contact companies having client defined target company attributes;
correlating titles and roles of contact individuals within contact companies;
creating a contact list based on contact roles and correlated contact roles of contact individuals within the identified contact companies; and
storing the created contact list in the validated contact database and the client customer relationship management system.

19. A method for capturing information for conversion into actionable sales leads, comprising the steps of:
collecting client website visitor information including the steps of:
embedding a tracking code segment within selected pages of a client's website;
accessing a selected page of the client's website by a website visitor;
collecting and storing information associated with the website visitor;
reverse-mapping an IP address associated with the website visitor to a name of a visitor company owner of the IP address;
matching the name of the visitor company owner to company and firmographic attributes and information in the validated contacts database;
matching the name of the visitor company to a commercial database of company information for verifying visitor company;
aggregating and sending visitor company information to a client user interface, a client customer relationship management system, and a data services system.
processing the collected information for generating a target list of contact companies, including the steps of;
identifying contact roles of contact individuals and contact companies having client defined target company attributes;
correlating titles and roles of contact individuals within contact companies;
creating a contact list based on contact roles and correlated contact roles of contact individuals within the identified contact companies; and
storing the created contact list in the validated contact database and the client customer relationship management system.

20. A method for capturing information for conversion into actionable sales leads, comprising the steps of:
collecting client customer relationship management system information, client website visitor information, and pre-identified companies information;
processing the collected information for generating a target list of contact companies;
guiding researchers through an explicit set of steps and transitions of an automated workflow and adaptive steering process for non-identified and non-correlated contact companies, comprising the steps of:
accepting a non-identified and non-correlated contact company as an input;
processing the input through the explicit set of steps and transitions of the automated workflow and adaptive steering process; and
providing an output selected from the group consisting of a hard full discover, a full discover, an assisted discover, an advantaged discover, a stale correlated hit, a fresh correlated hit, a stale direct hit, and a fresh direct hit.
